(19) United States
(12) Patent Application Publication
(10) Pub. No.: US 2014/0141922 A1
(43) Pub. Date: May 22, 2014

(54) SPUR-GEAR DIFFERENTIAL

(71) Applicant: Schaeffler Technologies AG & Co. KG, Herzogenaurach (DE)

(72) Inventors: Thorsten Biermann, Wachenroth (DE); Harald Martini, Herzogenaurach (DE)

(73) Assignee: Schaeffler Technologies AG & Co. KG, Herzogenaurach (DE)

(21) Appl. No.: 14/164,542

(22) Filed: Jan. 27, 2014

Related U.S. Application Data
(63) Continuation of application No. PCT/EP2012/063286, filed on Jul. 6, 2012.

(30) Foreign Application Priority Data
Jul. 28, 2011 (DE) 102011080002.6

(51) Int. Cl. F16H 48/11

(52) U.S. Cl. CPC F16H 48/11
USPC 475/252

(57) ABSTRACT

A differential (1; 20; 30) having a planet carrier (2; 14; 25), a first set of planet gears (3′; 17′; 26′), a second set of planet gears (4′; 18′; 27′), a first sun gear (5; 19; 28), a second sun gear (6; 21; 29), and a drive input wheel (8; 15; 31). An imaginary circle that is concentric to the central axis and on which the planet gears of one of the planet gear sets arranged radially farthest from the central axis has a diameter (D) that corresponds to at least two-times and at most 6.5-times a tooth width (S) of a widest tooth of the planet gears.

### INCORPORATION BY REFERENCE

The following documents are incorporated herein by reference as if fully set forth: International Application No. PCT/EP2012/063286, filed Jul. 6, 2012; and German Patent Application No. DE 10 2011 080 002.6, filed Jul. 28, 2011.

### FIELD OF THE INVENTION

The invention relates to a differential with a planet carrier, with a first set of planet gears, with a second set of planet gears, with a first sun gear and with a second sun gear, and with a drive wheel, wherein: the planet gears are each supported with a radial spacing to a central axis of the differential so that they can rotate about a rotational axis and are supported on the planet carrier, the first sun gear is arranged concentric to the central axis so that it can rotate about the central axis and coaxial to the second sun gear and is here in toothed engagement with each planet gear of the first set, the second sun gear is in toothed engagement with each planet gear of the second set so that it can rotate about the central axis, the drive wheel is a gear wheel of an angle drive for the toothed engagement with another gear wheel of the angle drive and is fastened on the planet carrier and wherein the rotational axes of the gear wheel and the additional gear wheel are inclined relative to each other.

### BACKGROUND

A differential of this type is described in WO2012/041551A1. In this differential of the class, in the toothed engagement of the teeth of the planet gears and sun gears, a gear wheel with a convex tooth flank profile is in toothed engagement with a gear wheel with a concave tooth flank profile. In addition, in WO2012/041551A1 it is described that in differentials of the class, the sun gears can also have the same number of teeth and each of the planet gears of the first set can have the same number of teeth as the planet gears of the second set.

Another differential is described in DE 10 2007 040 475A1. The planet gears are each supported with a radial spacing to a central axis of the differential so that they can rotate about a rotational axis, e.g., on planet pins. The planet pins are supported on the planet carrier. The first sun gear can rotate about the central axis and is arranged coaxial to the second sun gear and is in toothed engagement with each planet gear of the first set. The second sun gear is in toothed engagement with each planet gear of the second set.

### SUMMARY

The objective of the invention is to create a compact and load-bearing differential that can also be produced easily and economically.

This object is met by a differential having one or more features of the invention as discussed in detail below.

According to the invention, an imaginary circle that is concentric to the central axis and on which the planet gears of one of the sets arranged radially farthest from the central axis contact radially has a diameter that corresponds to at least two-times and at most 6.5-times a tooth width B of the widest tooth of the planet gears, that is, D/B=2≦V≦6.5.

The drive wheel is a gear wheel of an angle drive for the toothed engagement with another gear wheel of the angle drive. It is fastened to the planet carrier, wherein the rotational axes of the gear wheel and the additional gear wheel run inclined relative to each other. Angle drives are geared connections such as bevel gear drives and hypoid gears by means of which torques can be transmitted advantageously over an angle of 90°. In a conical drive, a drive conical gear (the pinion) meshes in a driven conical gear (the plate gear). Conical gears have a conical frustum-shaped base body. In hypoid drives, a special type of conical drive, the rotational axes of the conical gears in toothed engagement with each other are offset relative to each other so that they do not intersect, in contrast to the conical gear drive.

The planet carrier is advantageously formed from two shell-shaped plate parts that the planet gears and sun gears at least partially enclose. Alternatively, the planet carrier is formed from a shell-shaped plate part and from a cover part that are both held against each other axially, e.g., by advantageously at least six screws. The planet gears sit on planet pins so that they can rotate. Each planet pin is supported on one end in one of the plate parts so that it can either rotate or is fixed. The planet gears are supported so that they can rotate on the planet pins.

The drive wheel is concentric to the central axis, advantageously centered with a fit on the planet carrier. The drive wheel sits, for example, on an outer cylindrical surface of a plate part of the planet carrier. The central axis and the rotational axes of the sun gears correspond to each other. The fit is advantageously formed by a transition fit of cylindrical surfaces. In the transition fit, starting with equal nominal dimensions of the outer diameter of the planet carrier and the inner diameter of the drive wheel on the fit, the tolerance limits are set so that either a clearance, a congruence, or an over-dimension is produced in the gaps. For the clearance, the actual dimension of the outer diameter is less than that of the inner diameter. For congruence, the actual dimensions of each of the diameters are equal. For the over-dimension, the actual dimension of the outer diameter of the planet carrier is greater than the actual dimension of the inner diameter of the drive wheel. An example of a suitable transition fit of the cylindrical seat is a combination of the tolerances of the diameter of the drill hole of d^{H7} with those of the diameter of the shaft of dₙ₆.

The sun gears and planet gears are each the same width compared with each other. In one construction of the invention, the sun gears of the spur gear differential are axially set opposite each other spaced apart approximately by a gap that corresponds to the width of the area on which the planet gears are in toothed engagement. The teeth of the planet gears in toothed engagement with each of the sun gears project toward the axial center of the planet drive past the teeth of the sun gear and are in toothed engagement with each other only in a radial area over the gap. Thus it is ensured that despite the same number of teeth and the same module for the teeth, the planet gears of the first set do not collide with the teeth of the second sun gear and the planet gears of the second set do not collide with the teeth of the first sun gear.

In another construction of the invention, the tooth profile of one sun gear is shifted positive relative to a standard profile and the tooth profile of the other sun gear is shifted negative relative to the reference profile. The reference profile has characteristic values of the teeth, such as head, reference, or root circle diameter with which involute teeth are typically produced. For profile shifts, starting from the reference profile, the head, reference, and root circle are shifted negative, i.e., radially in the direction of the rotational axis, or positive, i.e., radially away from the rotational axis, so that a value with the units of “mm” is produced for the profile shift. The difference of the profile shift factor of one sun gear relative to the profile shift factor of the other sun gear is at least 1.5 on the differential according to the invention. Each profile shift factor is given from the division of the profile shift by the corresponding module m of the gear wheel. The module m is given by dividing the gear wheel diameter by the number of teeth of this gear wheel.

If a tangent is placed in the normal section on the involute surface at the intersecting point with the reference circle of the teeth, then the corresponding angle to a straight line placed through the centers of the gear wheels and running through the intersecting point is designated as the normal engagement angle αaₙ that advantageously equals at least 21°.

Differentials constructed in this way can have very compact and thus space-saving designs.

### BRIEF DESCRIPTION OF THE DRAWINGS

FIG. 1 is a schematic diagram of a differential according to one embodiment of the invention.

FIG. 2 shows an enlarged the detail of the bevel gears indicated at area Z (in broken lines) from FIG. 1

FIG. 3 shows a main view of a differential according to one embodiment of the invention as a closed unit.

FIG. 4 shows a main view of the differential of FIG. 3 from the other side.

FIG. 5 is a view of the opened differential.

FIG. 6 is a longitudinal section view of another embodiment of a differential.

FIG. 7 is a view showing the toothed engagement of the planet gears with the sun gears.

### DETAILED DESCRIPTION OF THE PREFERRED EMBODIMENTS

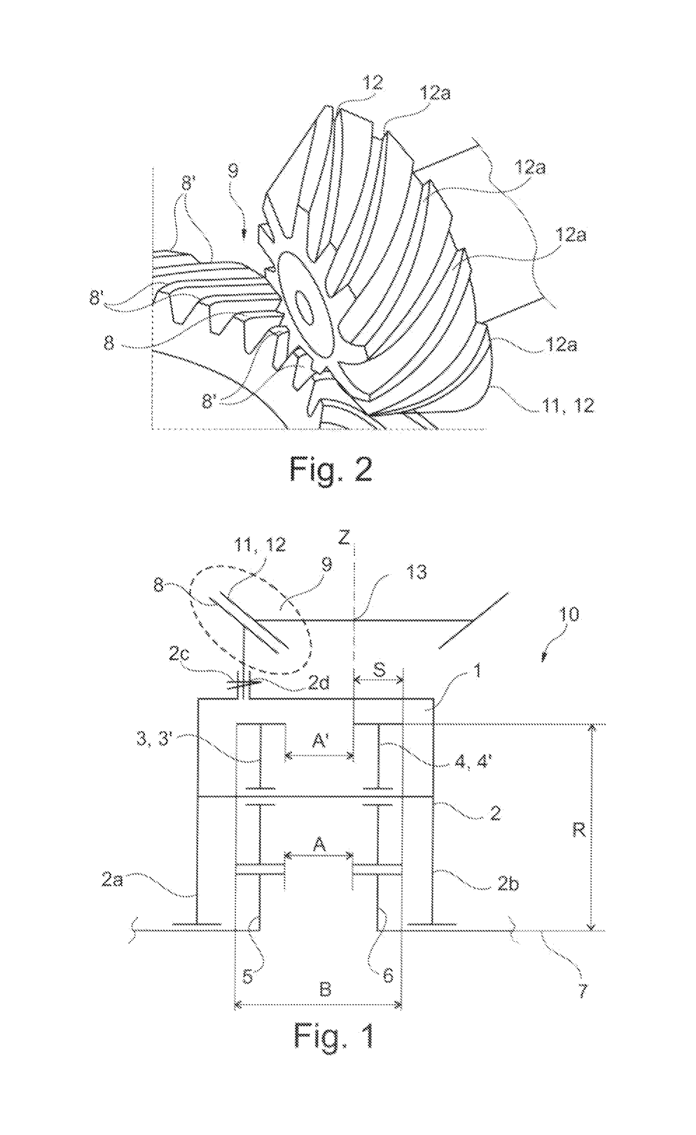

FIG. 1 shows schematically a differential unit 10 with an angle drive 9 and with a differential 1. The differential 1 is constructed as a spur gear differential 1 and has a planet carrier 2, a first set 3 of first planet gears 3′ and a second set 4 of second planet gears 4′, a first sun gear 5 and a second sun gear 6, and a drive wheel 8. The sun gears 5 and 6 are oriented coaxial to each other on the central axis 7 of the differential 1. The first sun gear 5 meshes with each planet gear 3′ of the first set 3. The second sun gear 6 meshes with each planet gear 4′ of the second set 4. The ratio 2R to B is relatively small, because an axial gap of width A that corresponds at least to the tooth width S of the planet gear 3′ or 4′ or the sun gear 5 or 6 must remain between the sun gears 5 and 6. In the region A′ over the axial gap A between the sun gears 5 and 6, each planet gear 3′ is in toothed engagement with a planet gear 4′, as can be seen graphically with the dashed line between the planet gears 3′ and 4′.

The planet carrier 2 is formed from two parts 2a and 2b. The parts 2a and 2b are screwed to each other via the flanges 2c and 2d. The drive wheel 8 engages with corresponding fasteners 8a between the flanges 2c and 2d and is screwed with these.

The angle drive 9 is formed from the drive wheel 8 that is a plate wheel made from a gear wheel 12 constructed as a pinion 11. The rotational axis of the drive wheel 8 corresponds to the central axis 7 that is the rotational axis of the planet carrier 2. The rotational axis 13 of the gear wheel runs perpendicular to the central axis 7.

FIG. 2 shows the detail Z from FIG. 1 which shows the teeth 8a of the drive wheel 8 on the angle drive 9 in toothed engagement with the teeth 12a of the gear wheel 12 and teeth 8′ of the drive wheel 8.

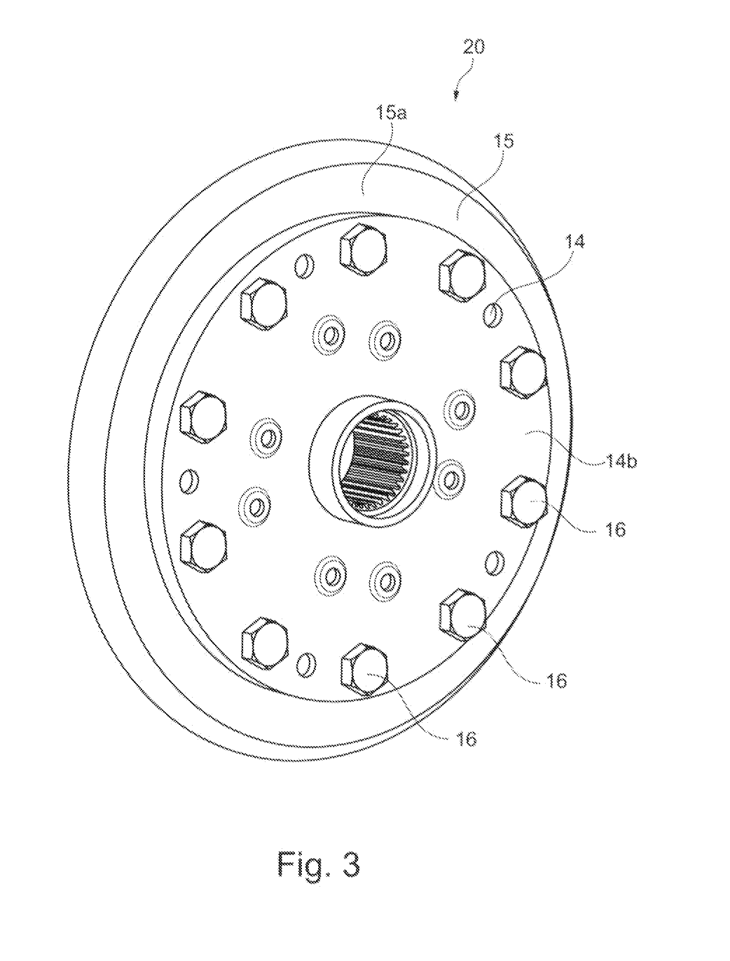

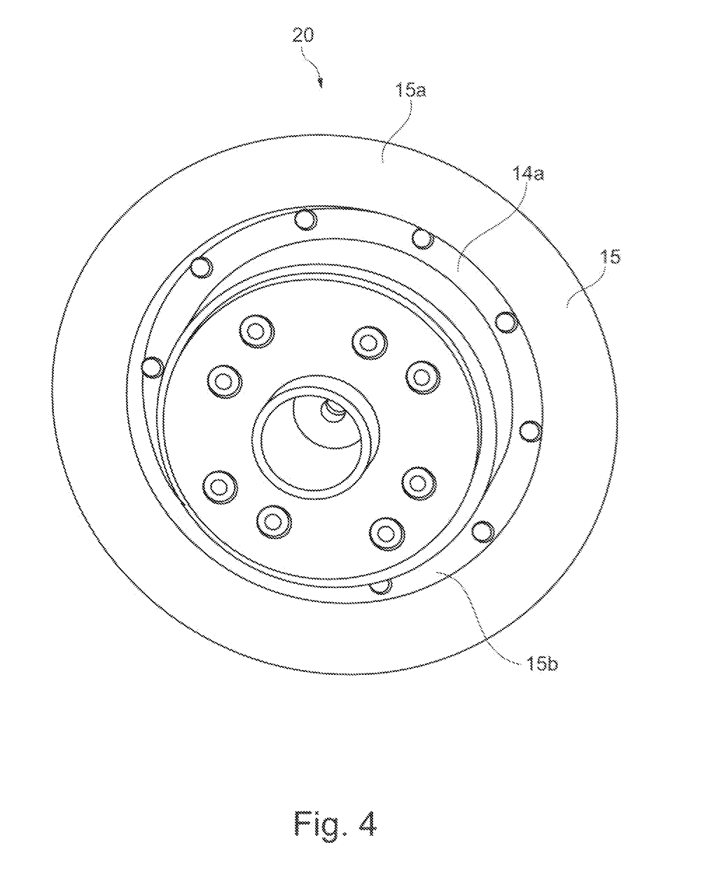

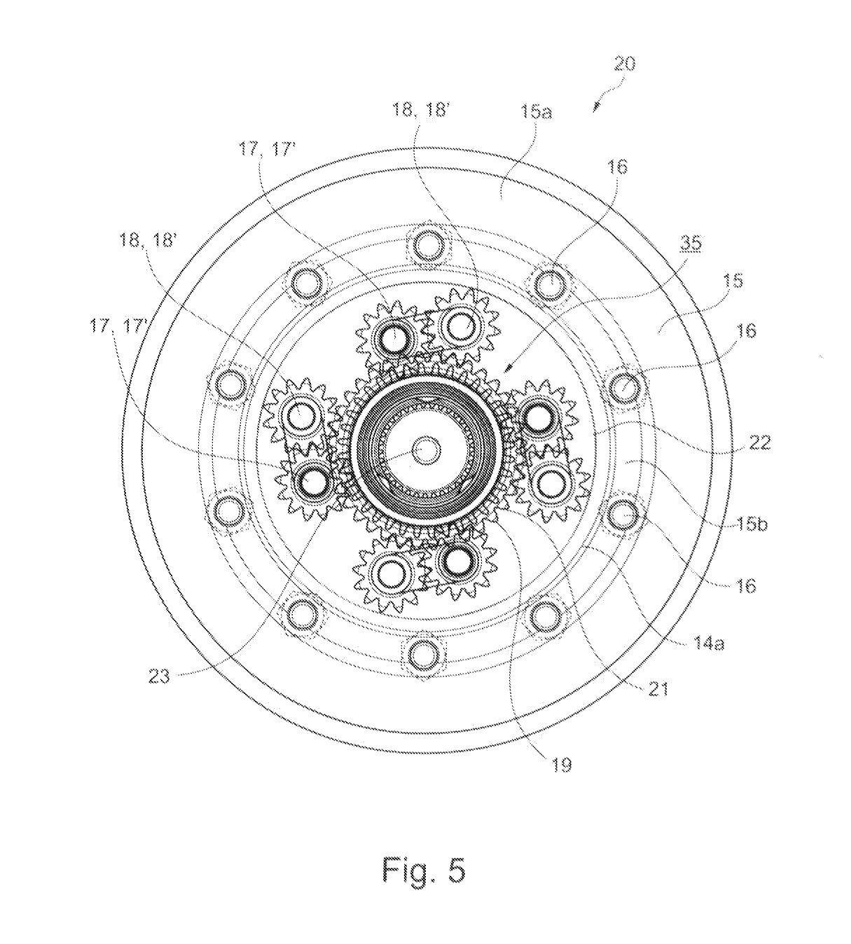

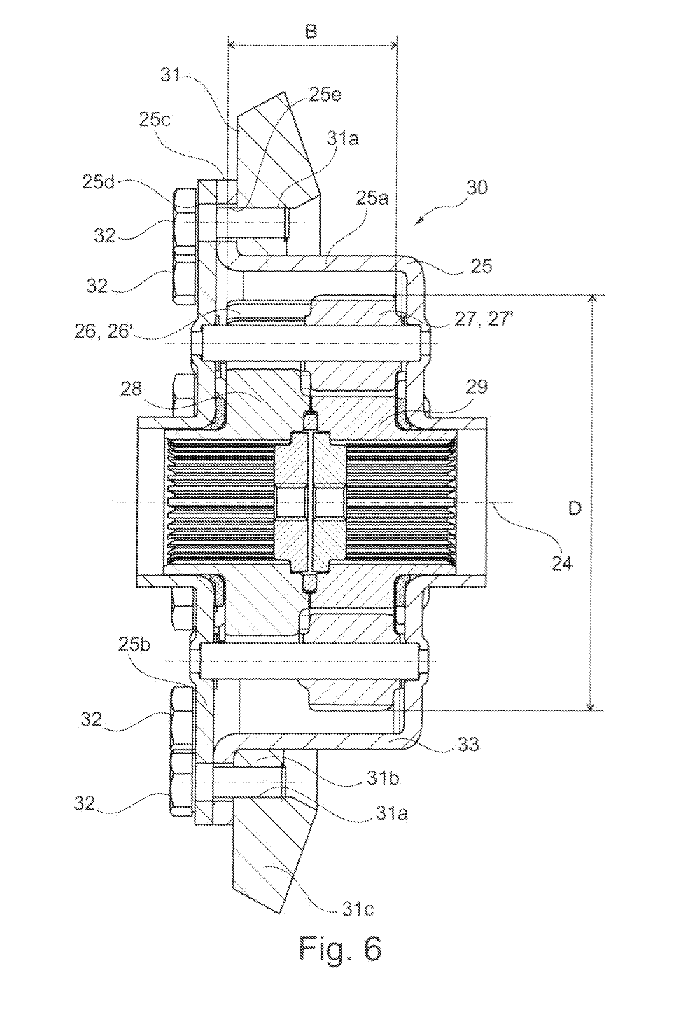

FIG. 3 shows a main view of an embodiment of a differential 20 as a closed unit. FIG. 4 shows a main view of the differential 20 from the other side. FIG. 5 shows the opened differential 20. The planet carrier 14 of the differential 20 is formed from two sheet parts 14a and 14b. The pot part 14a houses the planet drive 35 of the differential 20 that is visible in FIG. 6, a section of a front view. A cover 14b closes the pot part 14a. A drive wheel 15 sits on the outer cylindrical pot part 14a with a fit. Of the drive wheel 15, the cylindrical frustum-shaped base body 15a and a fastening ring 15b are shown. On the cylindrical frustum-shaped base body 15a, the not-shown teeth of the drive wheel 15 for the toothed engagement is constructed with a not-shown gear wheel of an angle drive. The fit is realized by means of the fastening ring 15b and the pot part 14a. In addition, the fastening ring 15b has inner threads in which screws 16 engage with which the pot part 14a, the cover 14b, and the drive gear wheel 15 are screwed axially to each other.

The radial inner dimensions of the pot part 14a are dependent on the radial installation space required by the planet gears 17′ of a first planet set 17 in toothed engagement with planet gears 18′ of the second set 18 and with a first sun gear 19 and also the second planet gears 18′ in toothed engagement with a second sun gear 21. The decisive factor for the dimensions is the diameter of a circle 22 that is placed on the outside around the second planet gears 18′ that are radially farthest away from the central axis 23 of the differential 20.

FIG. 6 shows an embodiment of a differential 30 in a longitudinal section along the central axis 24 of the differential 30. The differential 30 has a planet carrier 25, a first set 26 of first planet gears 26′, a second set 27 of second planet gears 27′, a first sun gear 28, a second sun gear 29, and a drive wheel 31 for engagement with a not-shown gear wheel of a not-shown angle drive.

The planet carrier 25 is formed from the sheet components 25a and 25b. In the pot part 25a, the sets 26 and 27 and the sun gears 28 and 29 are housed. The pot part 25a is closed on the side by the cover 25a. The pot parts 25a is provided with a flange 25c. The cover 25b has axial passage holes 25d whose arrangement corresponds to the pattern of the holes 25e in the flange 25c. Screws 32 that are each screwed into threaded holes 31a of the drive wheel 31 are placed through the holes 25d and 25e. The threaded holes 31 are formed in connection elements or in a connection ring 31b of the drive wheel. The connection elements and/or the connection ring 31b sit/sits with a fit 33 on an outer cylindrical surface of the pot part 25. The connection ring 31b transitions into the cylindrical frustum-shaped base body 31c of the drive wheel 31 on which the teeth, for example, of a hypoid gear, are formed.

The planet gears 26′ of the first set 26 are in toothed engagement with the sun gear 28. The planet gears 27′ of the second set 27 are in toothed engagement with the sun gear 29. The ratio V of D/B is: 2≦V≦6.5. D is the diameter of the circle 22 that is oriented concentric to the central axis 24 and contacts the planet gears 27′ on the outside.

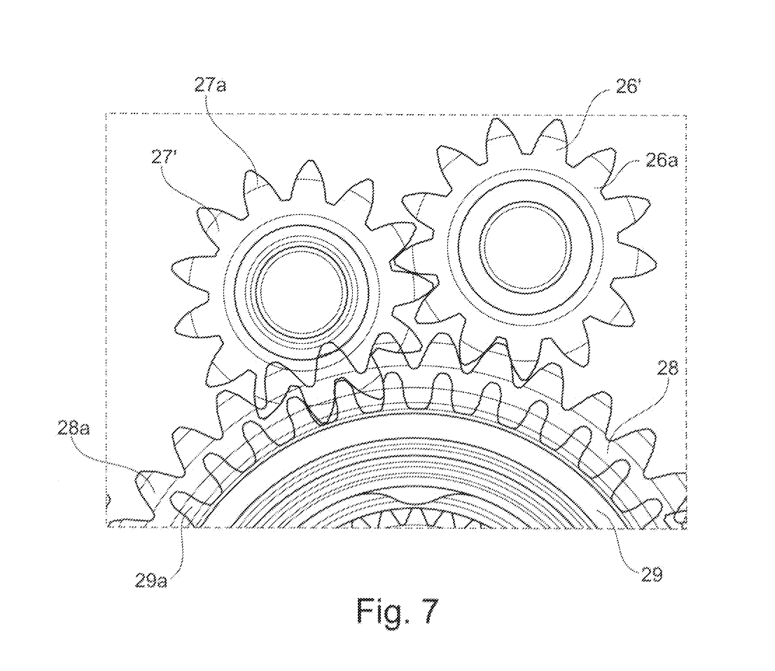

FIG. 7 shows the toothed engagement of the planet gears 26′ with the first sun gear 28 and the planet gears 27′ with the second sun gear 29. In addition, each planet gear 26′ is in toothed engagement with a planet gear 27′. The sun gears 28 and 29 are axially close to each other and are supported axially on one the other and have the same number of teeth 28a or 29a that are distributed with the same pitch on the periphery. The number of teeth 26a of the planet gears 26′ is equal to the number of teeth 27a of the planet gears 27′. The toothed profile of the teeth 28a is radially positive, that is, shifted outward. The toothed profile of the teeth 29a is radially negative, that is, shifted inward, so that the planet gears 26′ constructed as long planet gears 26′ do not collide with the teeth 29a of the second sun gear 29. The number of teeth 28a of the first sun gear 28 corresponds to the number of teeth 29a of the second sun gear 29.

1. A differential comprising a planet carrier, a first set of planet gears, a second set of planet gears, a first sun gear, a second sun gear, and a drive wheel,
the planet gears are each arranged with a radial spacing (R) to a central axis of the differential so that the planet gears rotate about a rotational axis and are supported on the planet carrier,
the first sun gear is arranged concentric to the central axis for rotation about the central axis and coaxial to the second sun gear and is in toothed engagement with each of the planet gears of the first set,
the second sun gear is arranged for rotation about the central axis and is in toothed engagement with each of the planet gears of the second set,
the drive wheel is a gear wheel of an angle drive for toothed engagement with another gear wheel of the angle drive and is fastened to the planet carrier, and rotational axes of the gear wheel and the additional gear wheel are inclined relative to each other,
and the first sun gear has a first number of teeth that is equal to a second number of teeth of the second sun gear, and each of the planet gears of the first set has a third number of teeth that is equal to a fourth number of teeth of each of the planet gears of the second set, each of the planet gears of the first set is in toothed engagement with a respective one of the planet gears of the second set, and an imaginary circle that is concentric to the central axis and on which the planet gears of one of the planet gear sets arranged radially farthest from the central axis has a diameter (D) that corresponds to at least two-times and at most 6.5-times a tooth width (S) of a widest tooth of the planet gears.

2. The differential according to claim 1, wherein the drive wheel has a frustum-shaped base body with teeth.

3. The differential according to claim 1, wherein the drive wheel is centered on the planet carrier concentric to the central axis.

4. The differential according to claim 2, wherein the drive wheel is centered by a fit on an externally cylindrical surface of the planet carrier.

5. The differential according to claim 1, wherein the planet carrier is formed from at least two parts between which the planet gears are arranged, and the parts are fastened to each other, and the drive wheel is centered on one of the parts.

6. The differential according to claim 1, wherein the planet carrier is formed from at least two parts between which the planet gears are arranged, and the parts are fastened to each other by screws and the drive wheel is centered on one of the parts.

7. The differential according to claim 5, wherein the parts of the planet carrier are fastened on the drive wheel by screws.

8. A differential drive unit including the differential according to claim 1, further including an angle drive having at least one gear wheel that is in toothed engagement with the drive wheel and having a rotational axis that extends perpendicular to the rotational axis of the drive wheel.
